(19) United States
(12) Patent Application Publication
(10) Pub. No.: US 2010/0150631 A1
(43) Pub. Date: Jun. 17, 2010

(54) SKEW CORRECTION DEVICE AND RECORDING APPARATUS

(75) Inventor: Yutao KOBAYASHI, Tatsuno-machi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/637,249

(22) Filed: Dec. 14, 2009

(30) Foreign Application Priority Data
Dec. 16, 2008 (JP) 2008-320068

(51) Int. Cl. G03G 15/00; B65H 9/16

(52) U.S. Cl. 399/395; 271/253; 271/254

(57) ABSTRACT

A skew correction device which performs positional correction of a sheet while a tip end of the sheet transported in accordance with rotation of a transport roller comes into contact with a gate member so as to deform the sheet to be bent, includes: a lower guide member including an inclination section which is disposed between the transport roller and the gate member in a transport direction of the sheet such that a side of the inclination section facing the gate member is disposed higher than the other side thereof facing the transport roller. Here, the inclination section is configured to move in at least one direction of the transport direction and a vertical direction.

### BACKGROUND

1. Technical Field

The present invention relates to a skew correction device and a recording apparatus which is provided with the skew correction device.

2. Related Art

In the past, as a skew correction device which carries out positional correction when a sheet such as a recording paper is obliquely transported, and has a paper feeding apparatus including a skew correction device which aligns the sheet while the tip end of the sheet transported by a transport roller comes into contact with a gate member such as a resistor roller so as to deform the sheet to be bent (for example, JP-A-7-285705).

In the paper feeding apparatus, as described in JP-A-7-285705, the transport roller is driven to rotate for a predetermined period of time in a state where the tip end of the sheet comes into contact with the gate member. Therefore, when the sheet is obliquely transported, the sheet rotates around one corner of the tip end which firstly comes into contact with the gate member until the other corner of the tip end comes into contact with the gate member, so that the positional correction is carried out.

In JP-A-7-285705, the bottom surface of the transport passage is provided with a protrusion, so that even the sheet with high rigidity can be reliably bent. However, since the protrusion is fixed to the transport passage, when the transporting sheets are different in rigidity, a bending direction is changed, so that the sheet may not come into reliable contact with the gate member.

Further, in addition to the paper feeding apparatus, when different kinds of sheets are subjected to the skew correction, the above-mentioned problem occurs commonly.

### SUMMARY

An advantage of some aspects of the invention is to provide a skew correction device and a recording apparatus including the skew correction device, which can properly carry out skew correction even when the kind of a sheet is different.

According to an aspect of the invention, there is provided a skew correction device which performs positional correction of a sheet while a tip end of the sheet transported in accordance with rotation of a transport roller comes into contact with a gate member so as to deform the sheet to be bent, including: a lower guide member including an inclination section which is disposed between the transport roller and the gate member in a transport direction of the sheet such that a side of the inclination section facing the gate member is disposed higher than the other side thereof facing the transport roller. Here, the inclination section is configured to move in at least one direction of the transport direction and a vertical direction.

According to such a configuration, the inclination section is caused to move in at least one direction of the transport direction and the vertical direction according to the kind of sheet, so that it is possible to adjust a bending direction of the sheet. Therefore, it is possible to properly carry out the skew correction even when the kind of the sheet is different.

In the skew correction device of the invention, the lower guide member further includes a rotating cam which has a cam section in a curved surface shape protruding upwardly from the inclination section in accordance with rotation thereof.

According to such a configuration, the rotating cam is rotated such that the cam section protrudes upwardly from the inclination section, so that it is possible that the sheet comes into contact with the cam section in a curved surface shape. Therefore, the frictional force which acts on the sheet in a direction against the transportation of the sheet is reduced, and the bending deformation of the sheet can be improved.

In the skew correction device of the invention, when the sheet is transported in accordance with rotation of the transport roller, the rotating cam is held in a state where the cam section protrudes upwardly from the inclination section until the sheet comes into contact with the gate member. After the sheet comes into contact with the gate member, the rotating cam is displaced such that the cam section does not protrude upwardly from the inclination section.

According to such a configuration, after the sheet comes into contact with the gate member, the rotating cam is displaced such that the cam section does not protrude upwardly from the inclination section. Therefore, it is possible that the cam section is withdrawn to a lower position in which unnecessary back tension applying to the sheet can be suppressed not to occur.

In the skew correction device of the invention, the inclination section is changeable in the inclination angle thereof.

According to such a configuration, the inclination angle of the inclination section is changed, so that the bending direction of the sheet can be adjusted. Therefore, it is possible to properly carry out the skew correction even when the kind of the sheet is different.

In the skew correction device of the invention, the inclination section includes a small roller of which a peripheral surface protrudes upwardly from the inclination section.

According to such a configuration, in the inclination section, there are provided the small rollers of which the peripheral surface protrudes upwardly from the inclination section. Therefore, the sheet comes into contact with the small rollers, so that it is possible to reduce the frictional force which acts on the sheet in a direction against the transportation of the sheet.

According to another aspect of the invention, there is provided a recording apparatus which includes: the skew correction device as described above; and a recording unit for performing a recording process on the sheet which is subjected to the positional correction.

According to such a configuration, the same effect as that of the skew correction device can be obtained.

### BRIEF DESCRIPTION OF THE DRAWINGS

The invention will be described with reference to the accompanying drawings, wherein like numbers reference like elements.

FIG. 1 is a diagram schematically illustrating a configuration of a recording apparatus according to an embodiment.

FIG. 2 is a plan view illustrating the vicinity of a register roller.

FIG. 3 is a side view illustrating the vicinity of a lower guide member.

### DESCRIPTION OF EXEMPLARY EMBODIMENTS

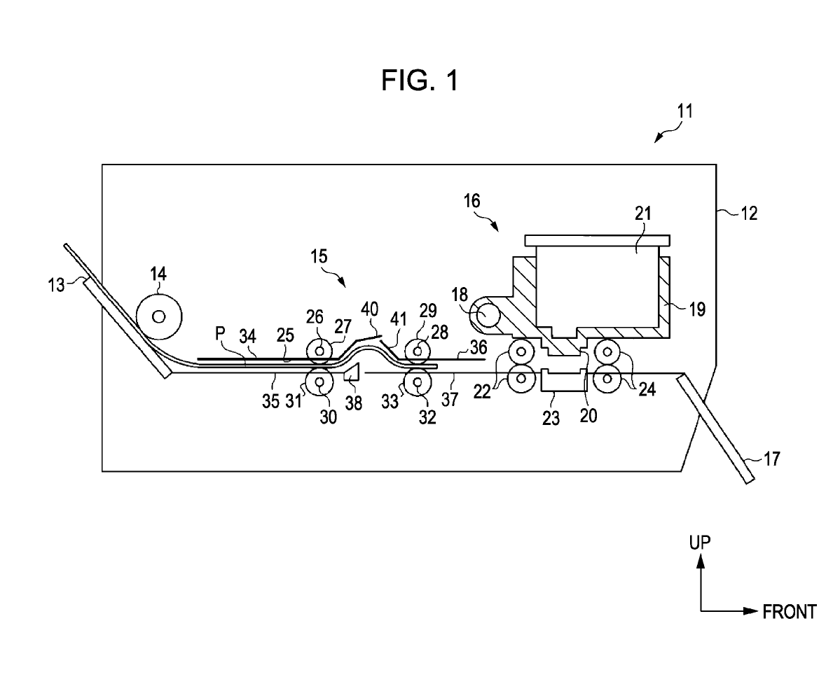

Hereinafter, the invention will be described through embodiments in which a printer is specified as a kind of a recording apparatus with reference to FIGS. 1 to 3. Further, in the following descriptions, when “longitudinal direction”, “horizontal direction”, and “vertical direction” are referred, it is assumed that these directions are indicated with reference to directions of arrows illustrated in each drawing.

A printer 11 as shown in FIG. 1 is a large-scale ink jet printer which can perform printing on a size of A1 or B1. The printer 11 is provided with a main frame 12, and a set unit 13, which can set the sheet P such as a recording paper, in a back surface side of the main frame 12.

In addition, the main frame 12 accommodates a feeding roller 14 for delivering the sheets P which are set on the set unit 13, a skew correction device 15 for performing positional correction of the delivered sheets P, and a printing device 16 to implement recording by performing a print process on the sheets P which are subjected to the positional correction. Furthermore, in a front surface side of the main frame 12, a discharge unit 17 is provided to guide the sheets P which are subjected to the print process and discharged from the main frame 12.

The printing device 16 extends in a horizontal direction (a direction perpendicular to the paper in FIG. 1). The printing device 16 is provided with a rod-shaped guide shaft 18 of which both the right and left ends are supported by the main frame 12, a carriage 19 which is supported by the guide shaft 18 so as to be reciprocally moved in the horizontal direction, and a recording head 20 which is provided on a lower surface side of the carriage 19. Then, the carriage 19 can be moved in the horizontal direction, which is a scanning direction, in accordance with the driving of a carriage motor (not shown).

In the main frame 12, an ink cartridge (not shown) containing ink is mounted so as to be attached thereto or detached therefrom, and the mounted ink cartridge is connected to an upstream end of an ink supply passage (not shown). On the carriage 19, a valve unit 21 is mounted such that a downstream end of the ink supply passage is connected thereto. Then, the ink contained in the ink cartridge is pressured and fed to the valve unit 21 through the ink supply passage by a pressing pump (not shown), so that the ink is supplied from the valve unit 21 to the recording head 20. In addition, on the lower surface side of the recording head 20, nozzle openings (not shown) are provided so as to eject the ink.

On the lower side of the carriage 19, there are provided a sending roller pair 22 disposed in a rear position of the recording head 20, a platen 23 which is a support base of the sheet P disposed in a lower position of the recording head 20 and in a forward position of the sending roller pair 22, and a sending roller pair 24 disposed in a forward position of the platen 23. Then, a sending process of transporting the sheet P by a predetermined distance toward the forward side which is the downstream side in the transport direction by the sending roller pairs 22 and 24, and a print process of ejecting ink from the nozzle openings of the recording head 20 which is moved in the scanning direction (horizontal direction) together with the carriage 19 are alternatively carried out, so that the recording process is carried out on the sheet P.

In addition, the skew correction device 15 is provided in the middle of the transport passage 25 through which the sheet P is transported toward the printing device 16. Specifically, in order to transport the sheet P, which is delivered by the feeding roller 14, toward the forward side which is the downstream side in the transport direction, there are provided on the transport passage 25 with a metal transport roller 27 which rotates in accordance with rotational driving of a driving shaft 26 and a resist roller 29 as a gate member which is disposed in the downstream side (forward side) in the transport direction from the transport roller 27 and is driven in accordance with rotational driving of a driving shaft 28. Therefore, on the lower side of the transport roller 27, a driven roller 31 made of hard rubber, which rotates about a rotary shaft 30 in accordance with the transport roller 27, is provided so as to make a pair with the transport roller 27. In addition, on the lower side of the resist roller 29, a driven roller 33, which rotates about a rotary shaft 32 in accordance with rotation of the resist roller 29, is provided so as to make a pair with the resist roller 29.

In the skew correction device 15, by making the transport roller 27 rotate in a counterclockwise direction in FIG. 1 in a state where the resist roller 29 has stopped rotating, the sheet P is transported toward the forward side so as to come into contact with the resist roller 29. Then, from this state, the transport roller 27 further rotates by a predetermined distance, so that skew correction is carried out on the sheet P.

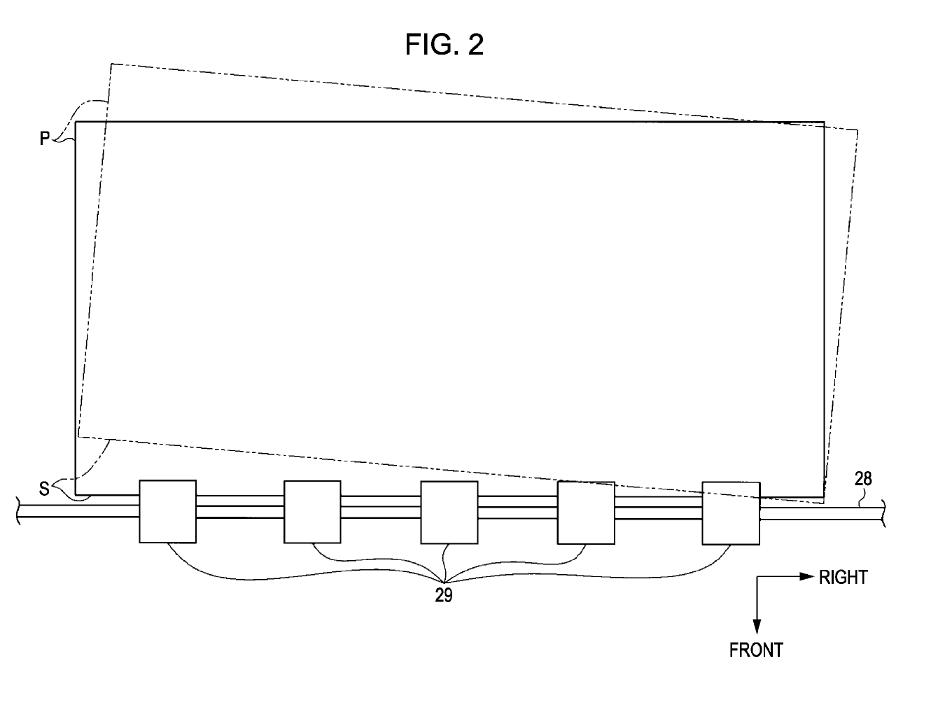

Here, as shown in FIG. 2, the skew correction means that positional correction is carried out on the sheet P such that the tip end S extending in a horizontal direction of the rectangular sheet P in plan view is to be an aligned state (the state illustrated in a solid line as shown in FIG. 2) perpendicular to the transport direction (longitudinal direction). That is, in order to properly carry out the recording process, it is necessary for the sheet P to be in the aligned state so as to be supplied to the printing device 16. However, since the tip end S of the sheet P is in a skewed state (the state illustrated in a double-dotted line as shown in FIG. 2) not perpendicular to the transport direction when the sheet is delivered or transported, the positional correction of the sheet P is carried out by the skew correction device 15.

Specifically, for example, when the sheet P is transported in the skewed state where the right end side of the sheet P is preceding, the right end side of the tip end S of the sheet P first comes into contact with the resist roller 29. Then, when the transport roller 27 is further driven to rotate from this state, the sheet P is slowly bent upward and rotates around the right end side which comes into contact with the resist roller 29, and the left end side of the tip end comes into contact with the resist roller 29, so that the positional correction is carried out. After such a positional correction is carried out, the resist roller 29 rotates in the counterclockwise direction in FIG. 1, so that the aligned sheet P is transported to the printing device 16.

Next, the configuration of the skew correction device 15 will be described.

As shown in FIG. 1, on the transport passage 25, a transport passage forming member 34 which is disposed in the vicinity of the transport roller 27, a transport passage forming member 35 which is disposed in the vicinity of the driven roller 31, a transport passage forming member 36 which is disposed in the vicinity of the resist roller 29, and a transport passage forming member 37 which is disposed in the vicinity of the driven roller 33. Then, the sheet P is transported from the upstream side (back side) to the downstream side (front side) of the transport passage 25, while the surface (upper surface) subjected to the print process is guided so as to face the transport passage forming members 34 and 36 and the rear surface (lower surface) is guided so as to face the transport passage forming members 35 and 37.

Between the transport passage members 35 and 37, there is disposed a lower guide member 38 which raises the tip end of the transported sheet P upwardly so as to promote bending deformation. In addition, on the front end side of the transport passage forming member 34, there is provided an upper guide member 40 which pushes the sheet P downwardly which is guided to the lower guide member 38 and transported in an inclined direction with respect to the transport direction. Further, on the back end side of the transport passage forming member 36, there is provided a guide plate 41 which guides the tip end of the sheet P to the resist roller 29. That is, in the skew correction device 15, the sheet P is induced by the lower guide member 38 and the bending deformation of the sheet P is controlled by the upper guide member 40 and the guide plate 41, so that the positional correction is carried out with high accuracy.

Next, the lower guide member 38 will be described, which is disposed between the transport roller 27 and the resist roller 29 in the transport direction of the sheet P.

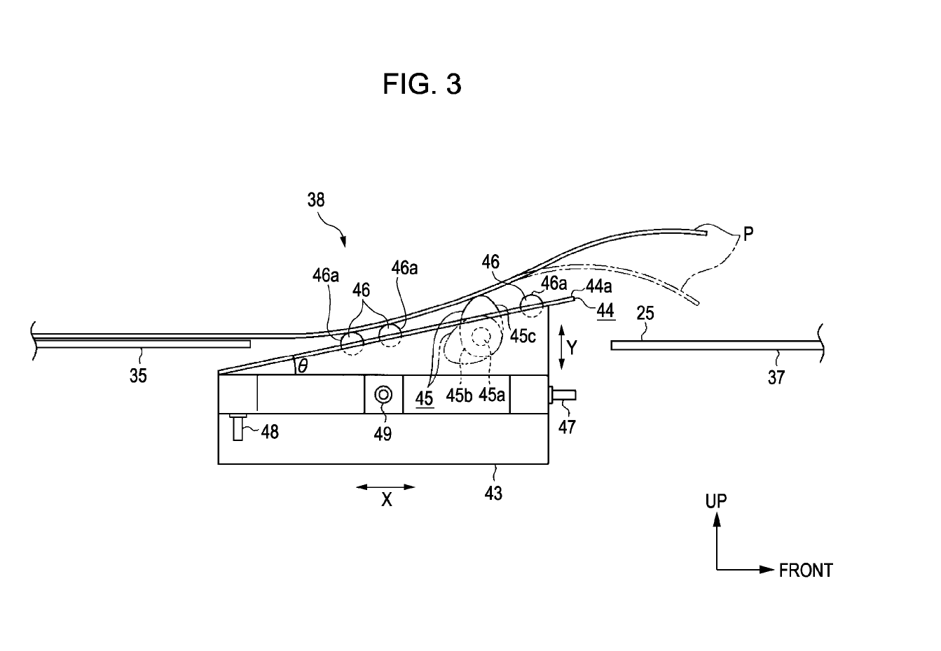

As shown in FIG. 3, the lower guide member 38 is provided with a moving mechanism 43, an inclination plate 44 and the rotating cam 45 which are supported by the moving mechanism 43. The inclination plate 44 is disposed such that the side of the inclination section 44a as the upper surface of the inclination plate 44 facing the resist roller 29 is disposed higher than the other side thereof facing the transport roller 27. In addition, a plurality (three) of small rollers 46 is provided in the inclination plate 44 along the transport direction (longitudinal direction) such that a peripheral surface 46a protrudes upwardly from the inclination section 44a.

The moving mechanism 43 serves as an inclination adjustment mechanism at the same time, and is provided with an adjusting dial 47 for causing the inclination plate 44 and the rotating cam 45 to move along the transport direction (X direction), an adjusting dial 48 for causing the inclination plate 44 and the rotating cam 45 to move along the vertical direction (Y direction), and an adjusting dial 49 for changing an inclination angle θ of the inclination plate 44. That is, the lower guide member 38 is configured such that the adjusting dials 47 to 49 are manually operated, so that the position and the inclination angle θ of the inclination section 44a can be changed, respectively. In this case, the inclination angle θ (0°<θ<90° of the inclination section 44a is set such that the side of the inclination section 44a facing the resist roller 29 is disposed higher than the other side thereof facing the transport roller 27.

In addition, the rotating cam 45 is configured to rotate in accordance with the rotation of a cam shaft 45a which is extended in the horizontal direction (a direction perpendicular to the paper in FIG. 3). The rotating cam 45 is provided with a first cam section 45b which is a curved surface such that the cross section thereof centered on the cam shaft 45a forms an accurately curved surface in a semicircle, and a second cam section 45c which is a curved surface so as to separate from the cam shaft 45a rather than the first cam section 45b. Then, in the rotating cam 45, when the sheet P is transported in accordance with the rotation of the transport roller 27, the second cam section 45c is held in a state (which is marked with a solid line as shown in FIG. 3) of protruding upwardly from the inclination section 44a and the peripheral surface 46a of the small rollers 46 until the sheet P comes into contact with the resist roller 29. Then, the second cam section 45c is displaced in a state (which is marked with a double-dotted chain line as shown in FIG. 3) of not protruding upwardly from the inclination section 44a and the peripheral surface 46a of the small rollers 46 after the sheet P comes into contact with the resist roller 29.

Next, operations of the lower guide member 38 configured as described above will be described.

The lower guide member 38 is operated such that the position and the inclination angle θ of the inclination section 44a can be adjusted in at least one direction of the transport direction and the vertical direction according to the rigidity of the sheet P on which the printing is performed. When the sheet P with high rigidity, for example, a thick paper, is subjected to printing, the inclination angle θ is set to be large such that the position of the inclination section 44a in the transport direction is close to the upstream (back side) and the position thereof in the vertical direction is raised. On the other hand, when the sheet P with low rigidity is subjected to printing, the inclination angle θ is set to be small such that the position of the inclination section 44a in the transport direction is close to the downstream (front side) and the position thereof in the vertical direction is lowered.

In other words, in the case of the sheet P with high rigidity as shown in FIG. 3, when the tip end of the sheet P to be transported is raised along the inclination section 44a, a bending degree of the sheet in the transport direction and the vertical direction becomes larger than that in the case of the sheet P with low rigidity marked with a chain line as shown in FIG. 3 due to stiffness strength of the sheet. Specifically, the length of the sheet P which is deformed to be bent in the transport direction is lengthened, and a bending top portion of the sheet P becomes higher.

Then, when a bending degree of the sheet P is changed, there are some concerns that a contact position to the resist roller 29 is changed and thus the skew correction is not properly carried out. Therefore, the inclination section 44a is caused to move in a direction of at least one direction of the transport direction and the vertical direction, so that the contact position to the resist roller 29 is adjusted. In addition, also by changing the inclination angle θ of the inclination section 44a, it is possible to carry out the same adjustment.

Further, the position and the inclination angle θ of the inclination section 44a in the transport direction and the vertical direction are not necessarily adjusted together; only a necessary adjustment may be carried out according to the kind of the sheet P.

For example, when the inclination section 44a is caused to move in the vertical direction and when in the transport direction, contact pressure and contact position between the sheet P and the upper guide member 40 are changed. Therefore, for example, when intensive contact pressure is required in serious consideration of the rotation of the sheet P, the inclination section 44a may be caused to move in the vertical direction. Alternatively, when the contact pressure of the sheet P on the upper guide member 40 does not increase and the position (the contact position connected with the upper guide member 40) in which the sheet is deformed to be bent is required to move toward the resist roller 29, the moving direction may be selected as needed, for example, the inclination section 44a is caused to move in the front direction.

In this embodiment, in the rotating cam 45, when the sheet P is transported in accordance with the rotation of the transport roller 27, the second cam section 45c is held in a state of protruding upwardly from the inclination section 44a and the peripheral surface 46a of the small rollers 46 until the sheet P comes into contact with the resist roller 29. Then, the second cam section 45c is displaced in a state of not protruding upwardly from the inclination section 44a and the peripheral surface 46a of the small rollers 46 after the sheet P comes into contact with the resist roller 29. That is, at a point of time when the sheet P comes into contact with the resist roller 29, the lower guide member 38 completes the role that the sheet P is raised upwardly so as to promote the bending deformation, and thus thereafter the sheet P is not needed to be raised. On the contrary, even after the sheet P comes into contact with the resist roller 29, when the lower guide member 38 raises the sheet P highly, unnecessary back tension is applied on the sheet P.

When the back tension is applied, there are some concerns that the sheet P is extended to the back side (toward the transport passage forming member 35), so that the rotation of the tip end S is hindered or the sheet P comes into slidable contact with the lower guide member 38, so that the rear surface thereof is scared. For this reason, after the sheet P comes into contact with the resist roller 29, the second cam section 45c is displaced to protrude upwardly from at least one of the inclination section 44a and the peripheral surface 46a of the small rollers 46, so that the second cam section 45c is retreated to a lower position in which the second cam section 45c does not come into contact with the sheet P. Therefore, the back tension applying to the sheet P is reduced.

In this embodiment, the small rollers 46 are provided on the inclination plate 44, so that the frictional force which acts on the sheet P in a direction against the transportation of the sheet P is reduced, and a load generated when the sheet P comes into slidable contact with the lower guide member 38 is reduced.

In addition, when the inclination angle θ is set high, there are some concerns that unnecessary back tension is generated. Therefore, when the moving mechanism 43 is adjusted, it is preferable that the position of the moving mechanism 43 be first adjusted in at least one direction of the transport direction and the vertical direction instead of increasing the inclination angle θ.

According to the embodiment as described above, the following effects can be obtained.

(1) The inclination section 44a is caused to move in a direction of at least one direction of the transport direction and the vertical direction according to the kind of the sheet P, so that it is possible to adjust a bending direction of the sheet P. Therefore, it is possible to properly carry out the skew correction even when the kind of the sheet P is different.

(2) The rotating cam 45 is rotated such that the second cam section 45c protrudes upwardly from the inclination section 44a, so that it is possible that the sheet P comes into contact with the second cam section 45c in a curved surface shape. Therefore, the frictional force which acts on the sheet P in a direction against the transportation of the sheet P is reduced, and the bending deformation of the sheet P can be promoted.

(3) After the sheet P comes into contact with the resist roller 29, the rotating cam 45 is displaced such that the second cam section 45c does not protrude upwardly from the inclination section 44a. Therefore, it is possible that the second cam section 45c is withdrawn to a lower position in which unnecessary back tension applying to the sheet P can be suppressed not to occur.

(4) The inclination angle θ of the inclination section 44a is changed, so that the bending direction of the sheet P can be adjusted. Therefore, it is possible to properly carry out the skew correction even when the kind of sheet P is different.

(5) In the inclination section 44a, there are provided the small rollers 46 of which the peripheral surface 46a protrudes upwardly from the inclination section 44a. Therefore, the sheet P comes into contact with the small rollers 46, so that it is possible to reduce the frictional force which acts on the sheet P in a direction against the transportation of the sheet P.

Further, the above-mentioned embodiment may be modified as other embodiments as described in the following.

With the skew correction device 15, it is not necessary to include the upper guide member 40 and the guide plate 41.

The lower guide member 38 may be configured without the rotating cam 45 and the small rollers 46. Further, when the rotating cam 45 and the small rollers 46 are not provided, the contact position between the lower guide member 38 and the sheet P is lowered in proportion to that much. Therefore, expecting the amount of change, the position and the inclination angle θ of the inclination section 44a are necessarily adjusted.

The small rollers 46 are rotatably supported in the inclination plate 44 in the vertical direction, and the sheet P comes into contact with the resist roller 29 in order for the peripheral surface 46a to protrude upwardly from the inclination section 44a until the sheet P comes into contact with the resist roller 29. Thereafter, the small rollers 46 may be caused to move in order not that the peripheral surface 46a does not protrude upwardly from the inclination section 44a. With such a configuration, without providing the rotating cam 45, the back tension applying to the sheet P can be suppressed.

The inclination section 44a may be configured not to change its inclination angle θ.

The adjustment of the moving mechanism 43 is not limited the dial adjustment manner. For example, the moving mechanism 43 may be provided with a control unit which can automatically set the position or the inclination angle of the inclination plate 44 according to the type of sheet P.

The small rollers 46 may be a roller in a columnar shape or in a cylindrical shape, or may be a spherical roller. In addition, the number of the small rollers 46 is not limited to three, but may be arbitrarily selected as 1 or more. The position of the small rollers 46 may be set on an arbitrary position in the inclination plate 44.

The first cam section 45b of the rotating cam 45 may be in a planar shape. Alternatively, after the sheet P comes into contact with the resist roller 29, the first cam section 45b configured of a curved surface of which the cross section is in a semicircle may protrude upwardly from the inclination section 44a, so that, similar to the small rollers 46, it is possible to reduce the frictional force which acts on the sheet P in a direction against the transportation of the sheet P.

After the sheet P comes into contact with the resist roller 29, the second cam section 45c is not necessarily displaced in order not to protrude upwardly from the inclination section 44a, but the second cam section 45c may be withdrawn to the lower position with which the sheet P does not come into contact or to the lower position in which unnecessary back tension can be suppressed not to occur. That is, as described in the embodiment, when the peripheral surface 46a of the small rollers 46 protrudes upwardly from the inclination section 44a, the second cam section 45c protrudes upwardly from the inclination section 44a and withdrawn to a position in which the second cam section 45c is positioned lowered than the peripheral surface 46a of the small rollers 46. In addition, even when the second cam section 45c protrudes upwardly from the peripheral surface 46a of the small rollers 46 and the inclination section 44a, the second cam section 45c is caused to move to a position (a second position) which is lower than a position (a first position) with which the sheet P is held until the sheet P comes into contact with the resist roller 29, so that unnecessary back tension can be suppressed not to occur.

The gate member is not limited to the resist roller 29, but may be realized as a planar-shaped member capable of moving in the vertical direction.

The sheet P is not limited to the recording paper, but may be realized as a member such as a plastic film.

The transport roller 27 is not limited to the metal, but a plastic or a hard rubber may be employed. In addition, these plural kinds of the transport rollers 27 may be mixed to be used. Similarly, the driven roller 31 is not limited to the hard rubber, but a metal or a plastic may be employed, or these may be mixed to be used.

In the above-mentioned embodiment, the recording apparatus is specified as the large-scale ink jet printer, but the invention is not limited thereto. For example, the skew correction device according to the above-mentioned embodiment may be provided at a small-scale recording apparatus which performs printing with a size of A4, a printer operated by a different manner such as an electrophotographic method, a FAX machine, a copying machine, or a multifunction machine which is provided with these plural functions. Further, there may be specified a liquid ejecting apparatus which ejects or discharges a liquid (which includes a liquid in which particles of a functional material consisting of solid matter such as pigments or metal particles are dispersed or mixed with a solvent, and a fluid such as gel) other than ink. For example, a liquid ejecting apparatus which ejects a liquid (fluid) in which a material such as an electrode material or a coloring material (pixel material) used for manufacturing a liquid crystal display, an electroluminescence (EL) display, and a surface emitting display, is dispersed or dissolved, a liquid ejecting apparatus which ejects a biological organic material used for manufacturing bio chips, a liquid ejecting apparatus which ejects a liquid as a sample used as a precise pipette may be employed. Furthermore, a liquid ejecting apparatus which ejects a lubricant onto a precision machine such as a clock or a camera using a pin point, a liquid ejecting apparatus which ejects transparent resin such as ultraviolet cure resin onto a substrate in order to form lenses (optical lenses) with a minute radius used in optical communication elements, a liquid ejecting apparatus which ejects an etching liquid such as an acid liquid or an alkali liquid in order to etch substrates, and a liquid ejecting apparatus which ejects a liquid (fluid) such as gel (for example, physical gel) may also be employed. The invention can be applied to any one of these liquid ejecting apparatus.

What is claimed is:

1. A skew correction device which performs positional correction of a sheet while a tip end of the sheet transported in accordance with rotation of a transport roller comes into contact with a gate member so as to deform the sheet to be bent, comprising:
a lower guide member including an inclination section which is disposed between the transport roller and the gate member in a transport direction of the sheet such that a side of the inclination section facing the gate member is disposed higher than the other side thereof facing the transport roller,
wherein the inclination section is configured to move in at least one direction of the transport direction and a vertical direction.

2. The skew correction device according to claim 1,
wherein the lower guide member further includes a rotating cam which has a cam section in a curved surface shape protruding upwardly from the inclination section in accordance with rotation thereof.

3. The skew correction device according to claim 2,
wherein when the sheet is transported in accordance with rotation of the transport roller, the rotating cam is held in a state where the cam section protrudes upwardly from the inclination section until the sheet comes into contact with the gate member, and after the sheet comes into contact with the gate member, the rotating cam is displaced such that the cam section does not protrude upwardly from the inclination section.

4. The skew correction device according to claim 1,
wherein the inclination section is changeable in inclination angle thereof.

5. The skew correction device according to claim 1,
wherein the inclination section includes a small roller of which a peripheral surface protrudes upwardly from the inclination section.

6. A recording apparatus comprising:
the skew correction device according to claim 1; and
a recording unit for performing a recording process on the sheet which is subjected to the positional correction.
